(19) United States
(12) Patent Application Publication
(10) Pub. No.: US 2017/0098384 A1
(43) Pub. Date: Apr. 6, 2017

(54) FARMING GUIDANCE ASSISTANCE DEVICE, FARMING GUIDANCE ASSISTANCE METHOD, AND COMPUTER-READABLE RECORDING MEDIUM

(71) Applicant: NEC Solution Innovators, Ltd., Koto-ku, Tokyo (JP)

(72) Inventor: Masaki HARA, Tokyo (JP)

(73) Assignee: NEC Solution Innovators, Ltd., Koto-ku, Tokyo (JP)

(21) Appl. No.: 15/311,619

(22) PCT Filed: May 12, 2015
(86) PCT No.: PCT/JP2015/063675

§ 371 Date: Nov. 16, 2016

(30) Foreign Application Priority Data
May 27, 2014 (JP) 2014-109333

(51) Int. Cl. G09B 19/00; G06Q 50/02; G09B 5/02; A01G 1/00; A01G 7/00

(52) U.S. Cl. CPC G09B 19/00; A01G 1/001; A01G 7/00; G09B 5/02; G06Q 50/02

(57) ABSTRACT

In order to assist an instructor in providing farming guidance to a producer, a farming guidance assistance apparatus (100) includes: a data management unit (11) that manages attributes of an agricultural product on agricultural lands on a per-land basis; and a notification statement generation unit (12) that determines whether applicable conditions that have been preset in one-to-one correspondence with notification statements of which the producer is to be notified are satisfied on a per-statement basis, and when there is a notification statement whose applicable condition is satisfied, outputs the notification statement together with information for specifying the producer to be notified of the notification statement.

### TECHNICAL FIELD

The present invention relates to a farming guidance assistance apparatus and a farming guidance assistance method that assist an instructor in providing farming guidance to a producer, and to a computer-readable recording medium having recorded therein a program for realizing the apparatus and method.

### BACKGROUND ART

Today, in regions that produce agricultural products, instructors of Japan Agricultural Cooperatives (JA) visit and provide guidance to farmers so that the farmers in the regions can maintain or exceed a certain level of quality. However, the number of instructors is small. In reality, there are many cases where one instructor is assigned approximately 200 farmers.

This gives rise to the problem that instructors cannot provide sufficient guidance to farmers due to a large burden on each one of the instructors. This problem could possibly be solved by providing appropriate guidance in accordance with the situation of each farmer using a computer system (see, for example, Patent Documents 1 and 2).

Specifically, Patent Document 1 discloses a system that outputs recommendations to optimize target agricultural lands. The system disclosed in Patent Document 1 first obtains such information as an underground temperature, underground humidity, pH, an amount of precipitation, an amount of evaporation, a temperature, and humidity from various types of sensors installed on target agricultural lands. Then, the system disclosed in Patent Document 1 cross-references the obtained information with a database in which agricultural data is accumulated, generates a recommendation that specifies when and how much fertilizers and pesticides to give based on the result of cross-referencing, and outputs the generated recommendation to farmers.

Patent Document 2 also discloses a system that outputs recommendations to farmers.

When the system disclosed in Patent Document 2 receives, as input, information indicating the statuses of agricultural products or the environmental statuses, the system cross-references the input information with a preset rule, specifies work that should be performed, and outputs a recommendations to farmers based on the specified work.

### LIST OF PRIOR ART DOCUMENTS

### Patent Document

Patent Document 1: JP 2002-215717A

Patent Document 2: JP 2012-039964A

### DISCLOSURE OF THE INVENTION

### Problems to be Solved by the Invention

The tasks that need to be performed by instructors include providing guidance directly to farmers, researching and managing the growth statuses on the agricultural lands of farmers assigned to the instructors, issuing notification statements to give notice of a collection date and the result of shipment to the farmers, and so on. Therefore, simply using the system disclosed in Patent Document 1 or 2 listed above does not sufficiently reduce a burden on instructors.

Furthermore, in practice, the systems disclosed in Patent Documents 1 and 2 listed above can only present a recommendation that conforms to a preset rule and the like. Therefore, in a situation that is unexpected for the systems, instructors need to give a recommendation based on their experiences, and hence it is necessary to reduce a burden on the instructors in terms of tasks other than the generation of recommendations.

An example of an object of the present invention is to provide a farming guidance assistance apparatus, a farming guidance assistance method, and a computer-readable recording medium that solve the above problems by streamlining the tasks of an instructor who provides agricultural assistance, thereby reducing a burden on the instructor.

### Means for Solving the Problems

To achieve the above object, a farming guidance assistance apparatus according to one aspect of the present invention assists an instructor in providing farming guidance to a producer, and includes: a data management unit that manages attributes of an agricultural product on agricultural lands on a per-land basis; and a notification statement generation unit that determines whether applicable conditions that have been preset in one-to-one correspondence with notification statements of which the producer is to be notified are satisfied on a per-statement basis, and when there is a notification statement whose applicable condition is satisfied, outputs the notification statement whose applicable condition is satisfied, together with information for specifying the producer to be notified of the notification statement whose applicable condition is satisfied.

In order to achieve the above object, a farming guidance assistance method according to another aspect of the present invention assists an instructor in providing farming guidance to a producer, and includes: (a) a step of managing attributes of an agricultural product on agricultural lands on a per-land basis; and (b) a step of determining whether applicable conditions that have been preset in one-to-one correspondence with notification statements of which the producer is to be notified are satisfied on a per-statement basis, and when there is a notification statement whose applicable condition is satisfied, outputting the notification statement whose applicable condition is satisfied, together with information for specifying the producer to be notified of the notification statement whose applicable condition is satisfied.

In order to achieve the above object, a computer-readable recording medium according to still another aspect of the present invention has recorded therein a program for assisting an instructor in providing farming guidance to a producer using a computer, and the program includes an instruction for causing the computer to execute: (a) a step of managing attributes of an agricultural product on agricultural lands on a per-land basis; and (b) a step of determining whether applicable conditions that have been preset in one-to-one correspondence with notification statements of which the producer is to be notified are satisfied on a per-statement basis, and when there is a notification statement whose applicable condition is satisfied, outputting the notification statement whose applicable condition is satisfied, together with information for specifying the producer to be notified of the notification statement whose applicable condition is satisfied.

### Advantageous Effects of the Invention

As described above, the present invention streamlines the tasks of an instructor who provides agricultural assistance, thereby reducing a burden on the instructor.

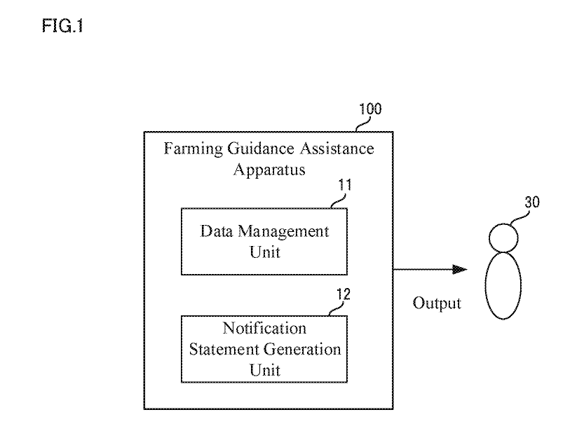

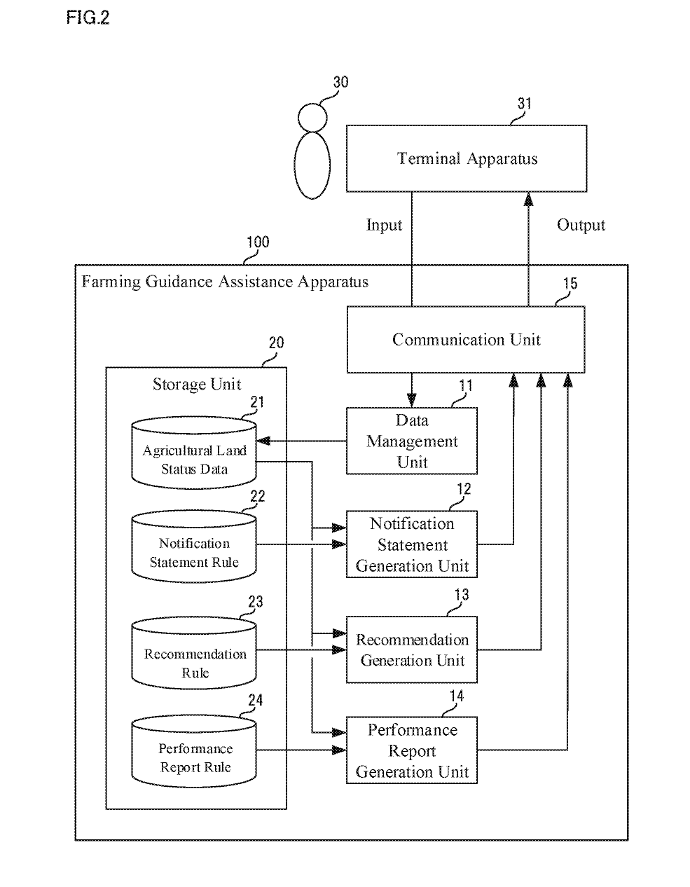

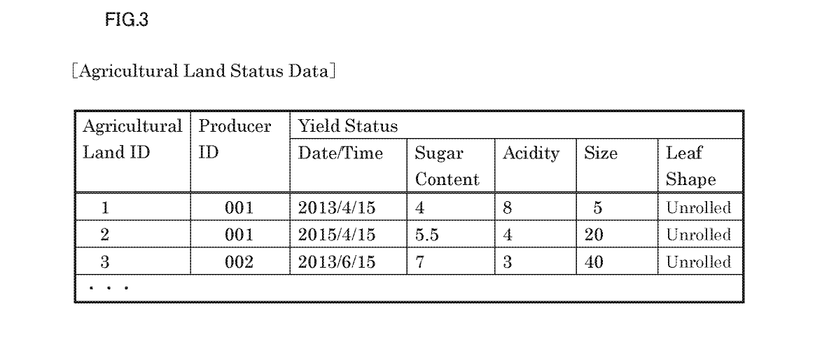

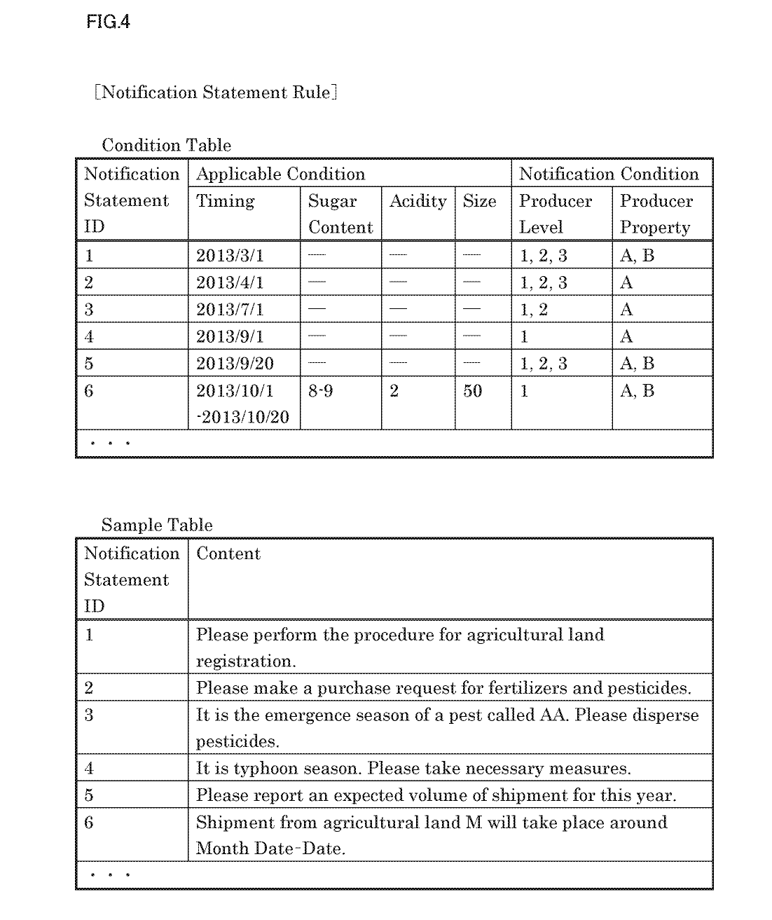

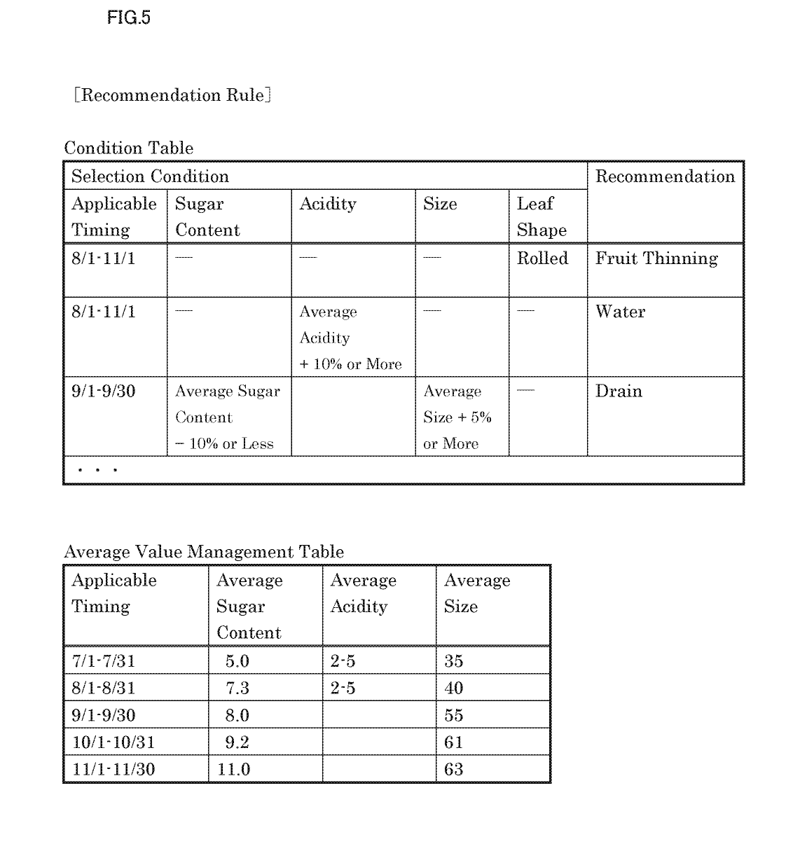

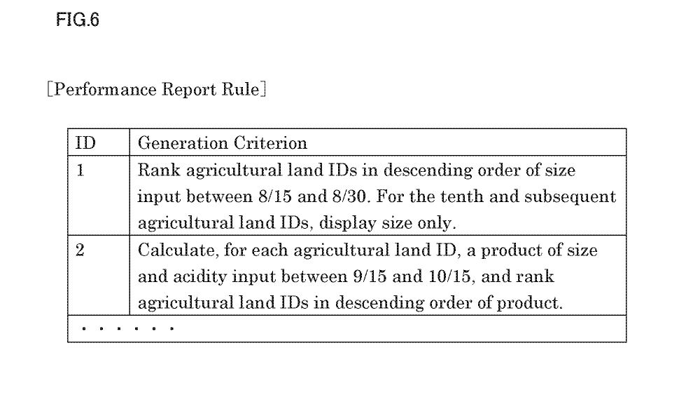

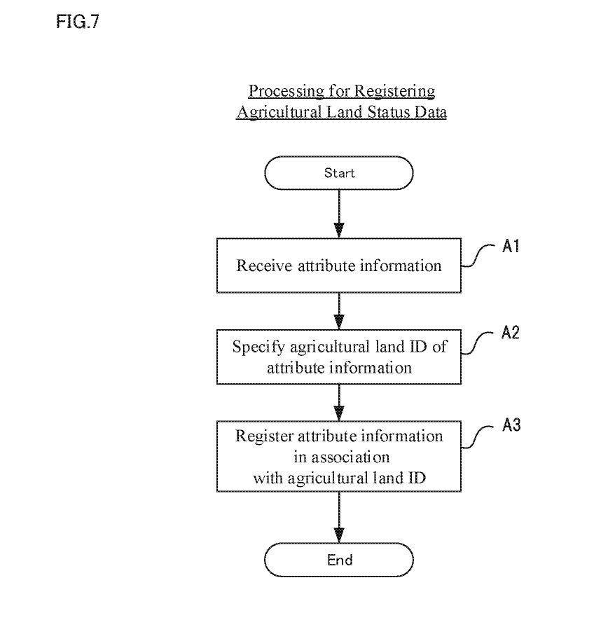

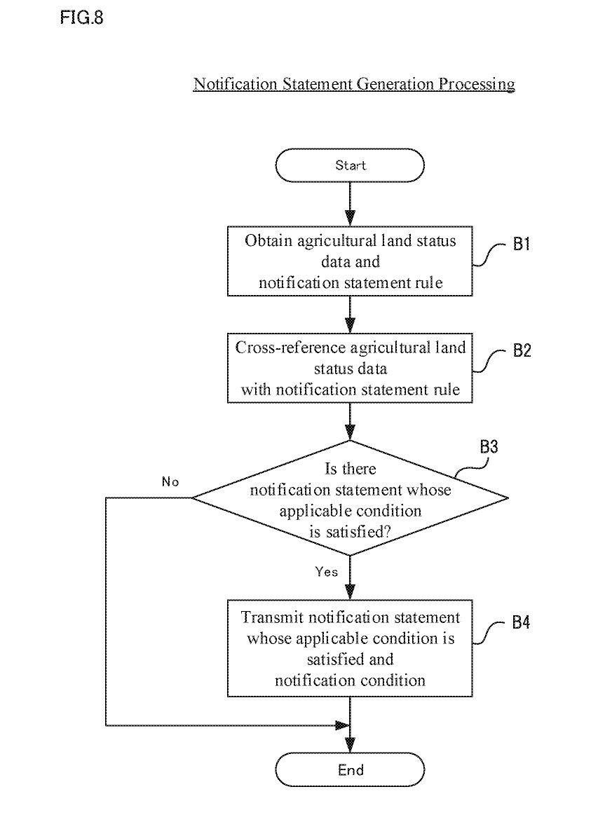

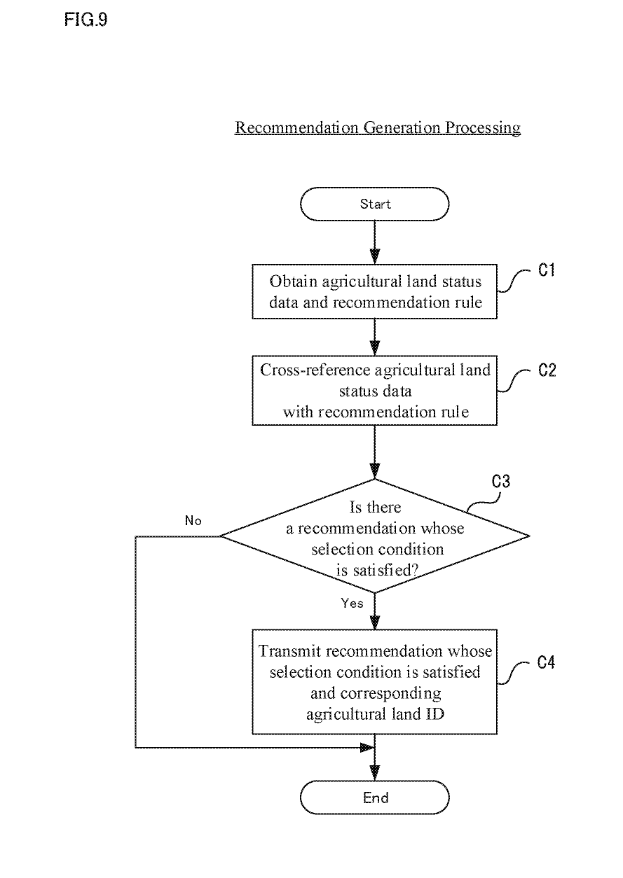

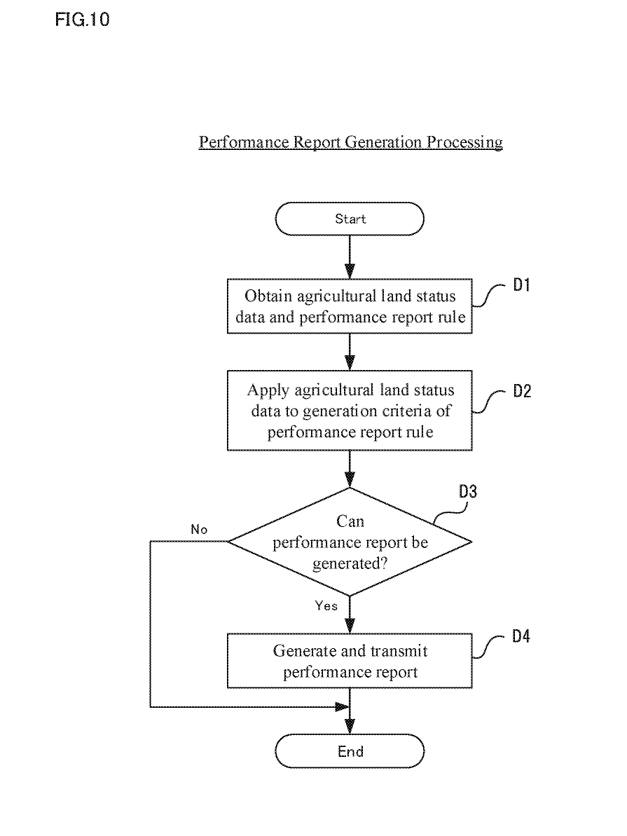

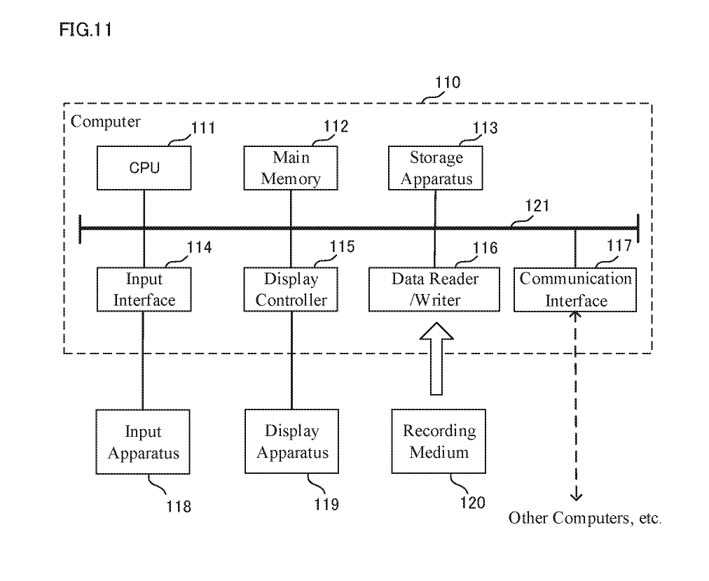

### BRIEF DESCRIPTION OF THE DRAWINGS

[FIG. 1] FIG. 1 is a block diagram showing a schematic configuration of a farming guidance assistance apparatus according to an embodiment of the present invention.

[FIG. 2] FIG. 2 is a block diagram showing a specific configuration of the farming guidance assistance apparatus according to the embodiment of the present invention.

[FIG. 3] FIG. 3 shows an example of agricultural land status data managed in the embodiment of the present invention.

[FIG. 4] FIG. 4 shows an example of a notification statement rule used in the embodiment of the present invention.

[FIG. 5] FIG. 5 shows an example of a recommendation rule used in the embodiment of the present invention.

[FIG. 6] FIG. 6 shows an example of a performance report rule used in the embodiment of the present invention.

[FIG. 7] FIG. 7 is a flowchart of operations that are performed when the farming guidance assistance apparatus according to the embodiment of the present invention executes processing for registering the agricultural land status data.

[FIG. 8] FIG. 8 is a flowchart of operations that are performed when the farming guidance assistance apparatus according to the embodiment of the present invention executes notification statement generation processing.

[FIG. 9] FIG. 9 is a flowchart of operations that are performed when the farming guidance assistance apparatus according to the embodiment of the present invention executes recommendation generation processing.

[FIG. 10] FIG. 10 is a flowchart of operations that are performed when the farming guidance assistance apparatus according to the embodiment of the present invention executes performance report generation processing.

[FIG. 11] FIG. 11 is a block diagram showing an example of a computer that realizes the farming guidance assistance apparatus according to the embodiment of the present invention.

### MODE FOR CARRYING OUT THE INVENTION

### Embodiment

With reference to FIGS. 1 to 8, the following describes a farming guidance assistance apparatus, a farming guidance assistance method, and a program according to an embodiment of the present invention.

### [Apparatus Configuration]

First, a configuration of the farming guidance assistance apparatus according to the embodiment of the present invention will be described using FIG. 1. FIG. 1 is a block diagram showing a schematic configuration of the farming guidance assistance apparatus according to the embodiment of the present invention.

A farming guidance assistance apparatus 100 according to the present embodiment, which is shown in FIG. 1, is an apparatus for assisting an instructor 30 in providing farming guidance to producers (not shown in FIG. 1). As shown in FIG. 1, the farming guidance assistance apparatus 100 includes a data management unit 11 and a notification statement generation unit 12.

The data management unit 11 manages attributes of agricultural products on agricultural lands on a per-land basis. The notification statement generation unit 12 determines whether applicable conditions that have been preset in one-to-one correspondence with notification statements of which the producers 30 are to be notified are satisfied on a per-statement basis. When there is a notification statement whose applicable condition is satisfied, the notification statement generation unit 12 outputs the notification statement whose applicable condition is satisfied, together with information for specifying one or more producers to be notified of the notification statement whose applicable condition is satisfied.

As such, the farming guidance assistance apparatus 100 can assist the instructor 30 in managing data of agricultural lands assigned to the instructor 30, and in generating notification statements. Accordingly, with the use of the farming guidance assistance apparatus 100, the tasks of the instructor are streamlined, thereby reducing a burden on the instructor.

The following is a more specific description of the configuration of the farming guidance assistance apparatus 100 according to the present embodiment using FIGS. 2 to 6. FIG. 2 is a block diagram showing a specific configuration of the farming guidance assistance apparatus according to the embodiment of the present invention.

As shown in FIG. 2, in the present embodiment, the farming guidance assistance apparatus 100 includes a recommendation generation unit 13, a performance report generation unit 14, a communication unit 15, and a storage unit 20 in addition to the data management unit 11 and the notification statement generation unit 12.

Also, the farming guidance assistance apparatus 100 is connected to a terminal apparatus 31 of the instructor 30 via a network (not shown in FIG. 2). The communication unit 15 is constituted by a communication device for performing data communication with the terminal apparatus 31. Therefore, the instructor 30 can transmit information for specifying attributes of agricultural products on the agricultural lands assigned to the instructor 30 (hereinafter, “attribute information”) to the farming guidance assistance apparatus 100 via the terminal apparatus 31. The instructor 30 can also receive notification statements and recommendations generated by the farming guidance assistance apparatus 100 via the terminal apparatus 31.

In the present embodiment, when the instructor 30 has transmitted attribute information via the terminal apparatus 31, the data management unit 11 receives the attribute information via the communication unit 15, stores attributes specified by the received attribute information as agricultural land status data 21 to the storage unit 20, and manages the agricultural land status data 21. For example, when the agricultural lands are orchards and the agricultural products are such fruits as apples and oranges, specific examples of the attributes include sugar content, acidity, a size, and a leaf shape.

FIG. 3 shows an example of the agricultural land status data managed in the embodiment of the present invention. In the present embodiment, the instructor 30 inputs the date/time, an agricultural land ID set to each agricultural land, and an ID of a corresponding producer (hereinafter, “producer ID”) together with attribute information, and transmits the input items. Therefore, as shown in FIG. 3, the attributes input by the instructor 30 (e.g., the sugar content, acidity, size, and leaf shape) are each stored to the storage unit 20 in association with the corresponding date/time, agricultural land ID, and producer ID. Note that in the present embodiment, the instructor 30 may obtain attribute information from the producers, or by directly visiting the agricultural lands by him/herself.

Also, in the present embodiment, the notification statement generation unit 12 determines whether the applicable conditions that are in one-to-one correspondence with the notification statements are satisfied by obtaining the agricultural land status data 21 from the storage unit 20 and cross-referencing the agricultural land status data 21 with a notification statement rule 22 stored in the storage unit 20 (see FIG. 4).

FIG. 4 shows an example of the notification statement rule used in the embodiment of the present invention. As shown in FIG. 4, in the present embodiment, the notification statement rule 22 is composed of a condition table and a sample table. Among these, the condition table is composed of applicable conditions and notification conditions that are in one-to-one correspondence with notification statement IDs. The sample table is composed of the contents of notification statements that are in one-to-one correspondence with the notification statement IDs.

In the condition table, each applicable condition is a condition for giving notice of a corresponding notification statement, and is set using at least one of a timing and the attributes of the agricultural products. The notification conditions are conditions for specifying a producer(s) to be a notification destination(s), and are set using producer levels and producer properties.

In the example of FIG. 4, there are three producer levels: 1 (not many years of experience), 2 (intermediate years of experience), and 3 (long years of experience). On the other hand, there are two producer properties: A (needing a great deal of guidance), and B (needing no guidance). Note that the instructor 30 may decide on the producer level and the producer property of each producer. Furthermore, no particular restriction is intended regarding classification of the producer levels and the producer properties.

When the notification statements registered with the notification statement rule includes a notification statement whose applicable condition is satisfied, the notification statement generation unit 12 outputs this notification statement and a corresponding notification condition to the communication unit 15. Then, the communication unit 15 transmits the output notification statement and notification condition to the terminal apparatus 31 of the instructor 30. This enables the instructor 30 to acknowledge the notification statement to be given and the notification destination(s), thereby reducing a burden on the instructor 30.

The recommendation generation unit 13 selects a recommendation whose preset selection condition is satisfied from among a plurality of recommendations that have been generated in advance to be presented to the producers, on a per-land basis, the preset selection condition being for an attribute managed by the data management unit 11. The recommendation generation unit 13 also outputs the selected recommendation. The present embodiment can assist the instructor also in generating recommendations.

In the present embodiment, the recommendation generation unit 13 selects a recommendation whose selection condition is satisfied, on a per-land basis (for each agricultural land ID), by obtaining the agricultural land status data 21 from the storage unit 20 and cross-referencing the agricultural land status data 21 with a recommendation rule 23 stored in the storage unit 20 (see FIG. 5).

FIG. 5 shows an example of the recommendation rule used in the embodiment of the present invention. As shown in FIG. 5, in the present embodiment, the recommendation rule is composed of a condition table and an average value management table.

Among these, the condition table is composed of selection conditions that are in one-to-one correspondence with recommendations. In the example of FIG. 5, each selection condition includes an applicable timing and at least one of the sugar content, acidity, size, and leaf shape. Although each selection condition including the sugar content, acidity, and/or size is set on the basis of an average value(s) in the example of FIG. 5, the selection conditions are not limited to being set in this style. Furthermore, as the average values change with the growth of the agricultural products, the average values are managed by an average value management table in one-to-one correspondence with timings in the present embodiment.

When there is a recommendation whose selection condition is satisfied, the recommendation generation unit 13 selects this recommendation, and outputs the selected recommendation and a corresponding agricultural land ID to the communication unit 15. Then, the communication unit 15 transmits the output recommendation and agricultural land ID to the terminal apparatus 31 of the instructor 30. This enables the instructor 30 to acknowledge the recommendation to be presented and a presentation destination, thereby reducing a burden on the instructor 30.

Although not clearly shown in FIG. 5, notification conditions may be set in the condition table of the recommendation rule 23, similarly to the condition table of the notification statement rule 22 shown in FIG. 4. This style presents a recommendation only to a producer who actually needs it.

The performance report management unit 14 generates a performance report indicating the ranking of the agricultural lands based on a generation criterion that uses the attributes managed by the data management unit 11, and outputs the generated performance report. Specifically, the performance report management unit 14 obtains the agricultural land status data 21 from the storage unit 20, and generates a performance report by applying the agricultural land status data 21 to a performance report rule 24 stored in the storage unit 20 (see FIG. 6).

FIG. 6 shows an example of the performance report rule used in the embodiment of the present invention. As shown in FIG. 6, in the present embodiment, the performance report rule is composed of generation criteria that are set in one-to-one correspondence with performance reports. Each generation criterion is set using one or more attributes, such as the sugar content, acidity, and size. The generation criteria are not limited to the example shown in FIG. 6. For example, the generation criteria may determine the ranking based on calculated deviation values of the attributes. The determined ranking may show only numerical values before harvesting, and may additionally show the agricultural land IDs and producers after harvesting.

The performance report management unit 14 also outputs the generated performance report to the communication unit 15. Then, the communication unit 15 transmits the output performance report to the terminal apparatus 31 of the instructor 30. Accordingly, the instructor 30 can obtain the performance report and distribute the performance report to the producers assigned to the instructor 30.

A description is now given of the advantageous effects of the performance report. For example, assume that a performance report with ID 1 or 2 shown in FIG. 6 has been generated and distributed to each producer via the instructor 30. In this case, each producer acknowledges a relative status of his/her own agricultural land, and could possibly become competitive against other producers. Therefore, each producer makes improvements with a willingness to produce better agricultural products than before. As a result, each producer is expected to achieve improved yieldability. Furthermore, some producers may ask a senior producer for guidance so as to incorporate know-how of the senior producer. This is expected to improve the skills of producers as a whole.

Furthermore, the generated performance report enables the instructor 30 to objectively grasp the growth statuses on the agricultural lands assigned to the instructor 30. Accordingly, the instructor 30 can provide more accurate guidance.

Although no particular restriction is intended regarding a display style of the performance report in the present embodiment, preferable display styles include a display style in which strong points and weak points of each agricultural land (each producer) can be listed. A specific example is a display style in which an overall performance and performances related to various measurement items are displayed as follows on a per-land basis: “overall=deviation value 57, size=deviation value 46, sugar content =deviation value 65, acidity=deviation value 51.” When such a display style is used, the instructor 30 can suggest an optimal cropping method (provide optimal cropping guidance) in accordance with strong points and weak points of each agricultural land (each producer).

Note that the performances displayed in the foregoing display style serve as examples. The performances to be displayed may be set by the instructor and the like for each variety. For example, when the agricultural products are citrus plants, it is preferable that the performances related to the size and the performances related to the sugar content be both displayed. On the other hand, when the agricultural products are leaf vegetables, such as spinach, it is preferable that the performances related to a plant height and the performances related to a leaf color be both displayed.

### [Apparatus Operations]

A description is now given of the operations of the farming guidance assistance apparatus 100 according to the embodiment of the present invention using FIGS. 7 to 10. In the following description, FIGS. 1 to 6 will be referred to as appropriate. In the present embodiment, the farming guidance assistance method is implemented by causing the farming guidance assistance apparatus 100 to operate. Therefore, the following description of the operations of the farming guidance assistance apparatus 100 applies to the farming guidance assistance method according to the present embodiment.

First, processing for registering the agricultural land status data will be described using FIG. 7. FIG. 7 is a flowchart of operations that are performed when the farming guidance assistance apparatus according to the embodiment of the present invention executes the processing for registering the agricultural land status data.

As shown in FIG. 7, the data management unit 11 first receives, via the communication unit 15, attribute information transmitted from the terminal apparatus 31 of the instructor 30 (step A1). Next, the data processing unit 11 specifies an agricultural land ID of the received attribute information (step A2).

Next, the data processing unit 11 stores the agricultural land ID specified in step A2 and the attribute information received in step A1, in association with each other, to the storage unit 20 as the agricultural land status data 21 (step A3). After step A3 has been executed, the data processing unit 11 ends the processing.

Each time attribute information is transmitted, the data processing unit 11 executes steps A1 to A3 repeatedly. As a result, the storage unit 20 stores the agricultural land status data 21 of various agricultural lands. Note that steps A1 to A3 may be executed periodically. In this case, whether attribute information has been transmitted is determined before step A1.

Notification statement generation processing will now be described using FIG. 8. FIG. 8 is a flowchart of operations that are performed when the farming guidance assistance apparatus according to the embodiment of the present invention executes the notification statement generation processing.

As shown in FIG. 8, the notification statement generation unit 12 first obtains the registered agricultural land status data 21 and the notification statement rule 22 from the storage unit 20 (step B1). Next, the notification statement generation unit 12 cross-references the agricultural land status data 21 obtained in step B1 with the notification statement rule 22 similarly obtained in step B1 (step B2), and determines whether there is a notification statement whose applicable condition is satisfied (step B3).

If it is determined in step B3 that there is no notification statement whose applicable condition is satisfied, the notification statement generation unit 12 ends the processing. On the other hand, if it is determined in step B3 that there is a notification statement whose applicable condition is satisfied, the notification statement generation unit 12 causes the communication unit 15 to transmit this notification statement and a corresponding notification condition to the terminal apparatus 31 of the instructor 30 (step B4). In the present embodiment, steps B1 to B4 are executed periodically at a regular interval. This enables the instructor 30 to acknowledge the notification statement of which a producer(s) is to be notified and a notification destination(s).

Recommendation generation processing will now be described using FIG. 9. FIG. 9 is a flowchart of operations that are performed when the farming guidance assistance apparatus according to the embodiment of the present invention executes the recommendation generation processing.

As shown in FIG. 9, the recommendation generation unit 13 first obtains the registered agricultural land status data 21 and the recommendation rule 23 from the storage unit 20 (step C1). Next, the recommendation generation unit 13 cross-references the agricultural land status data 21 obtained in step C1 with the recommendation rule 23 similarly obtained in step C1 (step C2), and determines whether there is a recommendation whose selection condition is satisfied (step C3).

If it is determined in step C3 that there is no recommendation whose selection condition is satisfied, the recommendation generation unit 13 ends the processing. On the other hand, if it is determined in step C3 that there is a recommendation whose selection condition is satisfied, the recommendation generation unit 13 causes the communication unit 15 to transmit this recommendation and a corresponding agricultural land ID to the terminal apparatus 31 of the instructor 30 (step C4). In the present embodiment, steps C1 to C4 are executed periodically at a regular interval. This enables the instructor 30 to acknowledge the recommendation to be presented and a producer to be a presentation destination.

Performance report generation processing will now be described using FIG. 10. FIG. 10 is a flowchart of operations that are performed when the farming guidance assistance apparatus according to the embodiment of the present invention executes the performance report generation processing.

As shown in FIG. 10, the performance report generation unit 14 first obtains the registered agricultural land status data 21 and the performance report rule 24 from the storage unit 20 (step D1). Next, the performance report generation unit 14 applies the agricultural land status data 21 obtained in step D1 to the performance report rule 24 similarly obtained in step D1 (step D2), and determines whether a performance report can be generated (step D3).

If it is determined in step D3 that a performance report cannot be generated, the performance report generation unit 14 ends the processing. On the other hand, if it is determined in step D3 that a performance report can be generated, the performance report generation unit 14 generates the performance report, and causes the communication unit 15 to transmit the generated performance report to the terminal apparatus 31 of the instructor 30 (step D4). In the present embodiment, steps D1 to D4 are executed periodically at a regular interval. This enables the instructor 30 to obtain the performance report and distribute the performance report to each producer.

As described above, the present embodiment can assist the instructor 30 in managing data of the agricultural lands assigned to the instructor 30, and in generating a notification statement and a recommendation. Therefore, the tasks of the instructor can be streamlined, and a burden on the instructor can be reduced. Furthermore, in the present embodiment, a performance report indicating the performances of producers is generated. With the use of the performance report, the instructor can improve the motivation of each producer, thereby improving the yieldabilities and skills of producers as a whole.

[Program]It is sufficient for the program according to the present embodiment to cause a computer to execute steps A1 to A3 shown in FIG. 7, steps B1 to B4 shown in FIG. 8, steps C1 to C4 shown in FIG. 9, and steps D1 to D4 shown in FIG. 10. The farming guidance assistance apparatus 100 and the farming assistance guidance method according to the present embodiment can be realized by installing this program in the computer and executing the installed program. In this case, a central processing unit (CPU) of the computer functions as the data management unit 11, the notification statement generation unit 12, the recommendation generation unit 13, and the performance report generation unit 14, and executes processing. A storage apparatus, such as a hard disk, provided in the computer functions as the storage unit 20.

Using FIG. 11, a description is now given of the computer that realizes the farming guidance assistance apparatus 100 by executing the program according to the present embodiment. FIG. 11 is a block diagram showing an example of the computer that realizes the farming guidance assistance apparatus according to the embodiment of the present invention.

As shown in FIG. 11, a computer 110 includes a CPU 111, a main memory 112, a storage apparatus 113, an input interface 114, a display controller 115, a data reader/writer 116, and a communication interface 117. These components are connected in such a manner that they can perform data communication with one another via a bus 121.

The CPU 111 executes various types of calculation by deploying the program (code) according to the present embodiment stored in the storage apparatus 113 to the main memory 112, and executing the deployed program according to a predetermined order. The main memory 112 is typically a volatile storage apparatus, such as a dynamic random-access memory (DRAM). The program according to the present embodiment is provided while being stored in a computer-readable recording medium 120. Note that the program according to the present embodiment may be distributed over the Internet connected via the communication interface 117.

Specific examples of the storage apparatus 113 include a hard disk and a semiconductor storage apparatus, such as a flash memory. The input interface 114 mediates data transmission between the CPU 111 and an input apparatus 118, such as a keyboard and a mouse. The display controller 115 is connected to a display apparatus 119, and controls display on the display apparatus 119.

The data reader/writer 116 mediates data transmission between the CPU 111 and the recording medium 120. The data reader/writer 116 reads out the program from the recording medium 120, and writes the result of processing of the computer 110 to the recording medium 120. The communication interface 117 is a device that functions as a communication unit, and mediates data transmission between the CPU 111 and other computers.

Specific examples of the recording medium 120 include: a general-purpose semiconductor storage device, such as CompactFlash® (CF) and Secure Digital (SD); a magnetic storage medium, such as a flexible disk; and an optical storage medium, such as a compact disc read-only memory (CD-ROM).

A part or an entirety of the above embodiment can be described as, but is not limited to, the following Supplementary Notes 1 to 15.

### (Supplementary Note 1)

A farming guidance assistance apparatus for assisting an instructor in providing farming guidance to a producer, the apparatus including: a data management unit that manages attributes of an agricultural product on agricultural lands on a per-land basis; and a notification statement generation unit that determines whether applicable conditions that have been preset in one-to-one correspondence with notification statements of which the producer is to be notified are satisfied on a per-statement basis, and when there is a notification statement whose applicable condition is satisfied, outputs the notification statement whose applicable condition is satisfied, together with information for specifying the producer to be notified of the notification statement.

### (Supplementary Note 2)

The farming guidance assistance apparatus according to Supplementary Note 1, wherein when the agricultural product is a fruit, the data management unit manages sugar content, acidity, a size, and a leaf shape as the attributes of the agricultural product.

### (Supplementary Note 3)

The farming guidance assistance apparatus according to Supplementary Note 1, wherein the applicable conditions are set using at least one of a timing and the attributes of the agricultural product.

### (Supplementary Note 4)

The farming guidance assistance apparatus according to Supplementary Note 1, further including a performance report management unit that generates a performance report indicating ranking of the agricultural lands and outputs the generated performance report, the performance report being generated based on a generation criterion that uses the attributes managed by the data management unit.

### (Supplementary Note 5)

The farming guidance assistance apparatus according to Supplementary Note 1, further including a recommendation generation unit that selects a recommendation whose preset selection condition is satisfied from among a plurality of recommendations that have been generated in advance to be presented to the producer and outputs the selected recommendation, on a per-land basis, the preset selection condition being for an attribute managed by the data management unit.

### (Supplementary Note 6)

A farming guidance assistance method for assisting an instructor in providing farming guidance to a producer, the farming guidance assistance method including: (a) a step of managing attributes of an agricultural product on agricultural lands on a per-land basis; and (b) a step of determining whether applicable conditions that have been preset in one-to-one correspondence with notification statements of which the producer is to be notified are satisfied on a per-statement basis, and when there is a notification statement whose applicable condition is satisfied, outputting the notification statement whose applicable condition is satisfied, together with information for specifying the producer to be notified of the notification statement.

### (Supplementary Note 7)

The farming guidance assistance method according to Supplementary Note 6, wherein when the agricultural product is a fruit, in step (a), sugar content, acidity, a size, and a leaf shape are managed as the attributes of the agricultural product.

### (Supplementary Note 8)

The farming guidance assistance method according to Supplementary Note 6, wherein the applicable conditions are set using at least one of a timing and the attributes of the agricultural product.

### (Supplementary Note 9)

The farming guidance assistance method according to Supplementary Note 6, further including (c) a step of generating a performance report indicating ranking of the agricultural lands and outputting the generated performance report, the performance report being generated based on a generation criterion that uses the attributes managed by step (a).

### (Supplementary Note 10)

The farming guidance assistance method according to Supplementary Note 6, further including (d) a step of selecting a recommendation whose preset selection condition is satisfied from among a plurality of recommendations that have been generated in advance to be presented to the producer and outputting the selected recommendation, on a per-land basis, the preset selection condition being for an attribute managed by step (a).

### (Supplementary Note 11)

A computer-readable recording medium having recorded therein a program for assisting an instructor in providing farming guidance to a producer using a computer, the program including an instruction for causing the computer to execute: (a) a step of managing attributes of an agricultural product on agricultural lands on a per-land basis; and (b) a step of determining whether applicable conditions that have been preset in one-to-one correspondence with notification statements of which the producer is to be notified are satisfied on a per-statement basis, and when there is a notification statement whose applicable condition is satisfied, outputting the notification statement whose applicable condition is satisfied, together with information for specifying the producer to be notified of the notification statement.

### (Supplementary Note 12)

The computer-readable recording medium according to Supplementary Note 11, wherein when the agricultural product is a fruit, in step (a), sugar content, acidity, a size, and a leaf shape are managed as the attributes of the agricultural product.

### (Supplementary Note 13)

The computer-readable recording medium according to Supplementary Note 11, wherein the applicable conditions are set using at least one of a timing and the attributes of the agricultural product.

### (Supplementary Note 14)

The computer-readable recording medium according to Supplementary Note 11, wherein the program further includes an instruction for causing the computer to execute (c) a step of generating a performance report indicating ranking of the agricultural lands and outputting the generated performance report, the performance report being generated based on a generation criterion that uses the attributes managed by step (a).

### (Supplementary Note 15)

The computer-readable recording medium according to Supplementary Note 11, wherein the program further includes an instruction for causing the computer to execute (d) a step of selecting a recommendation whose preset selection condition is satisfied from among a plurality of recommendations that have been generated in advance to be presented to the producer and outputting the selected recommendation, on a per-land basis, the preset selection condition being for an attribute managed by step (a).

Although the invention of the present application has been described above with reference to the embodiment, the invention of the present application is not limited to the above embodiment. Various changes that can be understood by a person skilled in the art can be made to the configurations and details of the invention of the present application within the scope of the invention of the present application.

The present application claims the benefit of priority from Japanese Patent Application No. 2014-109333, filed May 27, 2014, the disclosure of which is incorporated herein by reference in its entirety.

### INDUSTRIAL APPLICABILITY

As described above, the present invention streamlines the tasks of an instructor who provides agricultural assistance, thereby reducing a burden on the instructor. The present invention is useful in the field of agriculture.

### REFERENCE SIGNS LIST

11 data management unit
12 notification statement generation unit
13 recommendation generation unit
14 performance report generation unit
15 communication unit
20 storage unit
21 agricultural land status data
22 notification statement rule
23 recommendation rule
24 performance report rule
100 farming guidance assistance apparatus
110 computer
111 CPU
112 main memory
113 storage apparatus
114 input interface
115 display controller
116 data reader/writer
117 communication interface
118 input apparatus
119 display apparatus
120 recording medium
121 bus

What is claimed is:

1. A farming guidance assistance apparatus for assisting an instructor in providing farming guidance to a producer, the apparatus comprising:
a data management unit that manages attributes of an agricultural product on agricultural lands on a per-land basis; and
a notification statement generation unit that determines whether applicable conditions that have been preset in one-to-one correspondence with notification statements of which the producer is to be notified are satisfied on a per-statement basis, and when there is a notification statement whose applicable condition is satisfied, outputs the notification statement whose applicable condition is satisfied, together with information for specifying the producer to be notified of the notification statement.

2. The farming guidance assistance apparatus according to claim 1, wherein when the agricultural product is a fruit, the data management unit manages sugar content, acidity, a size, and a leaf shape as the attributes of the agricultural product.

3. The farming guidance assistance apparatus according to claim 1, wherein the applicable conditions are set using at least one of a timing and the attributes of the agricultural product.

4. The farming guidance assistance apparatus according to claim 1, further comprising a performance report generation unit that generates a performance report indicating ranking of the agricultural lands and outputs the generated performance report, the performance report being generated based on a generation criterion that uses the attributes managed by the data management unit.

5. The farming guidance assistance apparatus according to claim 1, further comprising a recommendation generation unit that selects a recommendation whose preset selection condition is satisfied from among a plurality of recommendations that have been generated in advance to be presented to the producer and outputs the selected recommendation, on a per-land basis, the preset selection condition being for an attribute managed by the data management unit.

6. A farming guidance assistance method for assisting an instructor in providing farming guidance to a producer, the farming guidance assistance method comprising:
(a) a step of managing attributes of an agricultural product on agricultural lands on a per-land basis; and
(b) a step of determining whether applicable conditions that have been preset in one-to-one correspondence with notification statements of which the producer is to be notified are satisfied on a per-statement basis, and when there is a notification statement whose applicable condition is satisfied, outputting the notification statement whose applicable condition is satisfied, together with information for specifying the producer to be notified of the notification statement.

7. The farming guidance assistance method according to claim 6, wherein when the agricultural product is a fruit, in step (a), sugar content, acidity, a size, and a leaf shape are managed as the attributes of the agricultural product.

8. The farming guidance assistance method according to claim 6, wherein the applicable conditions are set using at least one of a timing and the attributes of the agricultural product.

9. The farming guidance assistance method according to claim 6, further comprising
(c) a step of generating a performance report indicating ranking of the agricultural lands and outputting the generated performance report, the performance report being generated based on a generation criterion that uses the attributes managed by step (a).

10. The farming guidance assistance method according to claim 6, further comprising
(d) a step of selecting a recommendation whose preset selection condition is satisfied from among a plurality of recommendations that have been generated in advance to be presented to the producer and outputting the selected recommendation, on a per-land basis, the preset selection condition being for an attribute managed by step (a).

11. A non transitory computer-readable recording medium having recorded therein a program for assisting an instructor in providing farming guidance to a producer using a computer, the program comprising an instruction for causing the computer to execute:
(a) a step of managing attributes of an agricultural product on agricultural lands on a per-land basis; and
(b) a step of determining whether applicable conditions that have been preset in one-to-one correspondence with notification statements of which the producer is to be notified are satisfied on a per-statement basis, and when there is a notification statement whose applicable condition is satisfied, outputting the notification statement whose applicable condition is satisfied, together with information for specifying the producer to be notified of the notification statement.

12. The non transitory computer-readable recording medium according to claim 11, wherein when the agricultural product is a fruit, in step (a), sugar content, acidity, a size, and a leaf shape are managed as the attributes of the agricultural product.

13. The non transitory computer-readable recording medium according to claim 11, wherein the applicable conditions are set using at least one of a timing and the attributes of the agricultural product.

14. The non transitory computer-readable recording medium according to claim 11, wherein the program further includes an instruction for causing the computer to execute
(c) a step of generating a performance report indicating ranking of the agricultural lands and outputting the generated performance report, the performance report being generated based on a generation criterion that uses the attributes managed by step (a).

15. The non transitory computer-readable recording medium according to claim 11, wherein the program further includes an instruction for causing the computer to execute
(d) a step of selecting a recommendation whose preset selection condition is satisfied from among a plurality of recommendations that have been generated in advance to be presented to the producer and outputting the selected recommendation, on a per-land basis, the preset selection condition being for an attribute managed by step (a).
